(19) United States
(12) Patent Application Publication
(10) Pub. No.: US 2013/0216778 A1
(43) Pub. Date: Aug. 22, 2013

(54) FINGERPRINT-RESISTANT PRESSURE-SENSITIVE ADHESIVE TAPE

(71) Applicant: NITTO DENKO CORPORATION, (US)

(72) Inventors: Noboru YOSHIDA, Osaka (JP); Takahisa MIZUTORI, Osaka (JP); Toshihide SUZUKI, Osaka (JP); Masaaki SATOU, Osaka (JP)

(73) Assignee: NITTO DENKO CORPORATION, Osaka (JP)

(21) Appl. No.: 13/768,690

(22) Filed: Feb. 15, 2013

(30) Foreign Application Priority Data
Feb. 16, 2012 (JP) 2012-032004

(51) Int. Cl. C09J 7/02

(52) U.S. Cl. CPC C09J 7/0207
USPC 428/141

(57) ABSTRACT

A fingerprint-resistant pressure-sensitive adhesive tape includes has a core layer including a substrate layer and a colored layer, a pressure-sensitive adhesive layer, and a fingerprint-resistant treated layer. The substrate layer is formed of a plastic material, such as polyethylene terephthalate. The colored layer is laminated on one major surface of the substrate layer. The colored layer is a black printed layer formed, for example, by printing black ink. The pressure-sensitive adhesive layer is laminated on a major surface of the colored layer, the major surface being opposite to the substrate layer. An acrylic polymer is preferably used for the pressure-sensitive adhesive layer. The fingerprint-resistant treated layer is formed on a major surface of the substrate layer, the major surface being opposite to the colored layer. Wa of the outer surface of the fingerprint-resistant treated layer is 150 angstroms or more and Ra thereof is 2000 angstroms or more.

### BACKGROUND OF THE INVENTION

1. Field of the Invention

The present invention relates to a pressure-sensitive adhesive tape having fingerprint resistance. 2. Description of the Related Art

It is known that conventional and ordinary pressure-sensitive adhesive tapes have a form in which a pressure-sensitive adhesive layer is laminated on one surface of a substrate formed of a plastic material. The pressure-sensitive adhesive tapes are widely used as joint materials in various industrial fields, such as home electronic appliances, automobiles, and building materials. As the pressure-sensitive adhesive tapes are used in a wider range of applications, the cases where the tapes are used in visible areas become more increased. On the other hand, matte powder coating that is to be adhered to the surfaces of steel plates and is excellent in designing is known, on which a fingerprint trace is hardly left (Patent Document 1).

### PATENT DOCUMENT

[Patent Document 1] Japanese Patent Application Publication No. 1998-306237

A pressure-sensitive adhesive tape to be used in visible areas may be requested that a fingerprint trace is hardly left thereon, and in that case, matte coating containing a colorant is generally coated on a surface, as described in Patent Document 1. In such a coating, however, a colorant is diluted by the matte coating, and hence a desired coloring property may not be obtained in such a pressure-sensitive adhesive tape.

### SUMMARY OF THE INVENTION

The present invention has been made in view of such a problem, and a purpose of the invention is to provide a technique in which desired color can be achieved and a fingerprint can be made inconspicuous on the back surface of a pressure-sensitive adhesive tape.

An embodiment of the present invention is a fingerprint-resistant pressure-sensitive adhesive tape. The fingerprint-resistant pressure-sensitive adhesive tape comprises: a core layer including a substrate layer formed of a plastic material and a colored layer laminated on one major surface of the substrate layer; a pressure-sensitive adhesive layer laminated on one major surface of the core layer; and a fingerprint-resistant treated layer laminated on the other major surface of the core layer, in which Wa of the surface of the fingerprint-resistant treated layer, opposite to the core layer, is 150 angstroms or more and Ra thereof is 2000 angstroms or more.

In the fingerprint-resistant pressure-sensitive adhesive tape according to the aforementioned embodiment, the plastic material may be polyethylene terephthalate. Also, the pressure-sensitive adhesive layer may contain an acrylic polymer whose monomer major component is (meth)acrylic acid alkyl ester.

A pressure-sensitive adhesive tape in which the respective components described above are appropriately combined can be encompassed in the scope of the invention for which protection is sought by this application.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1 is a schematic view illustrating the layer structure of a fingerprint-resistant pressure-sensitive adhesive tape according to Embodiment 1; and

FIG. 2 is a schematic view illustrating the layer structure of a fingerprint-resistant pressure-sensitive adhesive tape according to Embodiment 2.

### DETAILED DESCRIPTION OF THE INVENTION

The invention will now be described by reference to the preferred embodiments. This does not intend to limit the scope of the present invention, but to exemplify the invention.

Hereinafter, the preferred embodiments of the present invention will de described with reference to the accompanying drawings.

### Embodiment 1

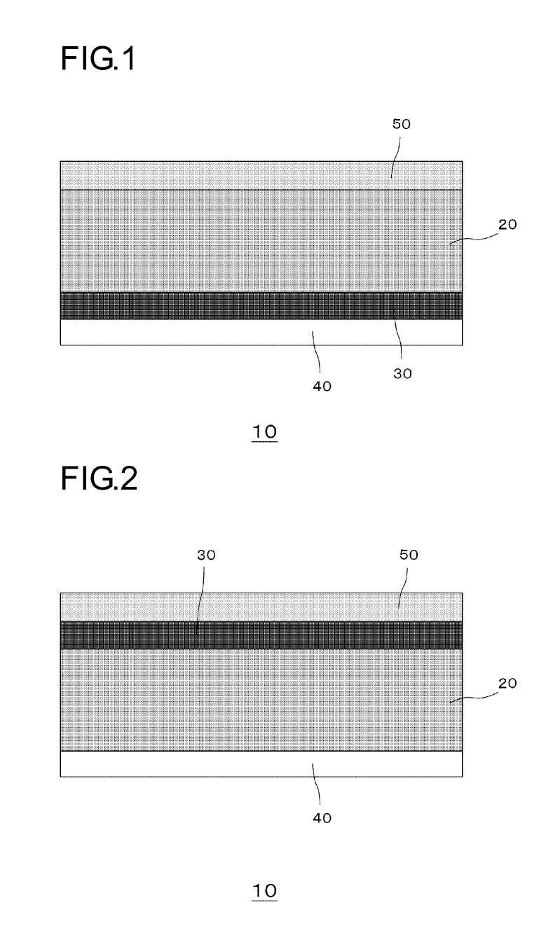

FIG. 1 is a schematic view illustrating the layer structure of a fingerprint-resistant pressure-sensitive adhesive tape 10 according to Embodiment 1. The fingerprint-resistant pressure-sensitive adhesive tape 10 comprises a core layer including a substrate layer 20 and a colored layer 30, a pressure-sensitive adhesive layer 40, and a fingerprint-resistant treated layer 50.

A plastic material is used for the substrate layer 20. Examples of the plastic material are not particularly limited, but include: polyesters, such as polyethylene terephthalate and polybutylene terephthalate; polyolefins, such as polyethylene and polypropylene; polyamide; polyamide; and polycarbonate, etc. The substrate layer 20 is obtained by forming the aforementioned plastic material into a film shape or a sheet shape. Black pigment, such as carbon black, may be added to the substrate layer 20. That is, a layer obtained by forming a plastic material, to which black pigment, such as carbon black, has been added, into a film shape or a sheet shape can be used. The thickness of the substrate layer 20 is not particularly limited, but is preferably, for example, more than 0 μm to 500 μm or less, and more preferably 2 to 500 μm. Alternatively, the thickness of the substrate layer 20 may be 5 to 500 μm, or 10 to 100 μm.

The colored layer 30 is laminated on one major surface of the substrate layer 20. In the present embodiment, the colored layer 30 is a black printed layer formed, for example, by printing black ink on the substrate layer 20. In addition to that, the colored layer 30 is formed by a method, such as gravure printing, screen printing, or the like. The color of the colored layer can be appropriately changed, other than black, to white, yellow, blue, red, green, or the like, in accordance with the use purpose of the tape. The thickness of the colored layer 30 is preferably, for example, more than 0 μm to 5 μm or less, more preferably 0.3 μm to 5 μm, still more preferably 0.5 μm to 5 μm, still more preferably 0.6 to 3 μm, and still more preferably 0.8 to 2 μm.

The pressure-sensitive adhesive layer 40 is laminated on a major surface of the colored layer 30, the major surface being opposite to the substrate layer 20. The material for the pressure-sensitive adhesive layer 40 is not particularly limited, but various pressure-sensitive adhesives, such as an acrylic pressure-sensitive adhesive, a rubber pressure-sensitive adhesive, and a silicone pressure-sensitive adhesive, can be used. Among them, an acrylic pressure-sensitive adhesive containing, as a major component, an acrylic polymer (A) can be preferably used. The acrylic polymer (A) contains, as a monomer unit, 50% by mass or more of (meth)acrylic acid alkyl ester having a C1-20 linear or branched alkyl group. In the aforementioned acrylic polymer (A), (meth)acrylic acid alkyl ester having a C1-20 alkyl group can be used alone or in combination of two or more thereof. The acrylic polymer (A) can be obtained by subjecting the (meth)acrylic acid alkyl ester to polymerization (e.g., solution polymerization, emulsion polymerization, UV polymerization), along with a polymerization initiator.

The ratio (R) of the (meth)acrylic acid alkyl ester having a C1-20 alkyl group is 50% by mass R 99.9% by mass, preferably 60% by mass R 95% by mass, and more preferably 70% by mass R 93% by mass, based on the total mass of the monomer components for preparing the acrylic polymer (A).

Examples of the (meth)acrylic acid alkyl ester having a C1-20 alkyl group include, for example: (meth)acrylic acid C1-20 alkyl esters, preferably (meth)acrylic acid C2-14 alkyl esters, and more preferably (meth)acrylic acid C2-10 alkyl esters, such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, and (meth)acrylic acid eicosyl. Herein, the (meth)acrylic acid alkyl ester means an acrylic acid alkyl ester and/or a methacrylic acid alkyl ester, and all of the “(meth) . . . ” expressions have the same meaning.

Examples of the (meth)acrylic acid esters, other than the (meth)acrylic acid alkyl esters, include, for example: (meth)acrylic acid esters having an alicyclic hydrocarbon group, such as cyclopentyl(meth)acrylate, cyclohexyl(meth)acrylate, and isoborny(meth)acrylate; (meth)acrylic acid esters having an aromatic hydrocarbon group, such as phenyl(meth)acrylate; and (meth)acrylic acid esters obtained from terpene compound derivative alcohols, etc.

For the purpose of modifying cohesive force, heat resistance, and cross-linking property, etc., the acrylic polymer (A) may contain, if necessary, another monomer component (copolymerizable monomer) that is copolymerizable with the (meth)acrylic acid alkyl ester. Accordingly, the acrylic polymer (A) may contain a copolymerizable monomer along with the (meth)acrylic acid alkyl ester as a major component. A monomer having a polar group can be preferably used as the copolymerizable monomer.

Specific examples of the copolymerizable monomer include: carboxyl group-containing monomers, such as acrylic acid, methacrylic acid, carboxy ethyl acrylate, carboxy pentylacrylate, itaconic acid, maleic acid, fumaric acid, crotonic acid, and isocrotonic acid; hydroxyl group-containing monomers, such as (meth)acrylic acid hydroxyalkyls including (meth)acrylic acid hydroxyethyl, (meth)acrylic acid hydroxypropyl, (meth)acrylic acid hydroxybutyl, (meth)acrylic acid hydroxyhexyl, (meth)acrylic acid hydroxyoctyl, (meth)acrylic acid hydroxydecyl, (meth)acrylic acid hydroxylauryl, and (4-hydroxymethyl cyclohexyl)methyl methacrylate; acid anhydride group-containing monomers, such as maleic acid anhydride and itaconic acid anhydride; sulfonic acid group-containing monomers, such as styrene sulfonic acid, allyl sulfonic acid, 2-(meth)acrylamide-2-methylpropanesulfonic acid, (meth)acrylamide propanesulfonic acid, sulfopropyl(meth)acrylate, and (meth)acryloyloxy naphthalenesulfonic acid; phosphate group-containing monomers, such as 2-hydroxyethyl acryloyl phosphate; (N-substituted)amide monomers, such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylol propane(meth)acrylamide, N-methoxymethyl(meth)acrylamide, and N-butoxymethyl(meth)acrylamide; succinimide monomers, such as N-(meth)acryloyloxy methylene succinimide, N-(meth)acryloyl-6-oxy hexamethylene succinimide, and N-(meth)acryloyl-8-oxy hexamethylene succinimide; maleimide monomers, such as N-cyclohexylmaleimide, N-isopropylmaleimide, N-laurylmaleimide, and N-phenylmaleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; vinyl esters, such as vinyl acetate and vinyl propionate; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine and N-vinyl morpholine, N-vinyl carboxylic acid amides; lactam monomers, such as N-vinyl caprolactam; cyano-containing monomers, such as acrylonitrile and methacrylonitrile; (meth)acrylic acid aminoalkyl monomers, such as (meth)acrylic acid aminoethyl, (meth)acrylic acid N,N-dimethylaminoethyl, and (meth)acrylic acid t-butylaminoethyl; (meth)acrylic acid alkoxy alkyl monomers, such as (meth)acrylic acid methoxyethyl and (meth)acrylic acid ethoxyethyl; styrene monomers, such as styrene and α-methylstyrene; epoxy group-containing acrylic monomers, such as (meth)acrylic acid glycidyl; glycol acrylic ester monomers, such as (meth)acrylic acid polyethylene glycol, (meth)acrylic acid polypropylene glycol, (meth)acrylic acid methoxy ethylene glycol, and (meth)acrylic acid methoxy polypropylene glycol; acrylic acid ester monomers having a heterocycle, halogen atom, silicon atom, or the like, such as (meth)acrylic acid tetrahydrofurfuryl, fluorine(meth)acrylate, and silicone(meth)acrylate; olefin monomers, such as isoprene, butadiene, and isobutylene; vinyl ether monomers, such as methyl vinyl ether and ethyl vinyl ether; vinyl esters, such as vinyl acetate and vinyl propionate aromatic vinyl compounds, such as styrene and vinyl toluene; olefins or dienes, such as ethylene, butadiene, isoprene, and isobutylene; vinyl ethers, such as vinyl alkyl ether; vinyl chloride; (meth)acrylic acid alkoxy alkyl monomers, such as (meth)acrylic acid methoxyethyl and (meth)acrylic acid ethoxyethyl; sulfonic acid group-containing monomers, such as vinyl sulfonate sodium; imide group-containing monomers, such as cyclohexyl maleimide and isopropyl maleimide; isocyanate group-containing monomers, such as 2-isocyanate ethyl(meth)acrylate; fluorine atom-containing (meth)acrylate; and silicon atom-containing (meth)acrylate, etc. These copolymerizable monomers can be used alone or in combination of two or more thereof.

When the acrylic polymer (A) contains a copolymerizable monomer along with a (meth)alkyl acid alkyl ester as a major component, carboxyl group-containing monomers can be preferably used. Among them, an acrylic acid can be preferably used. The use amount of the copolymerizable monomer is not particularly limited, but the copolymerizable monomer can be contained in an amount usually within a range of 0.1 to 30% by mass, preferably within a range of 0.5 to 20% by mass, and more preferably within a range of 1 to 15% by mass, based on the total mass of the monomer components for preparing the acrylic polymer (A).

By containing 0.1% by mass or more of the copolymerizable monomer, a decrease in the cohesive force of the pressure-sensitive adhesive tape can be prevented, and high shearing force can be acquired. Further, by containing 30% by mass or less of the copolymerizable monomer, it can be prevented that the cohesive force thereof may become too large, and the tackiness at normal temperature (25° C.) can be improved.

A polyfunctional monomer may be contained, if necessary, in the acrylic polymer (A) in order to adjust the cohesive force of the acrylic pressure-sensitive adhesive layer 40 to be formed.

Examples of the polyfunctional monomer include, for example:(poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecane diol di(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, butyldiol(meth)acrylate, and hexyldiol(meth)acrylate, etc. Among them, trimethylolpropane tri(meth)acrylate, hexanediol di(meth)acrylate, and dipentaerythritol hexa(meth)acrylate can be preferably used. The polyfunctional (meth)acrylate can be used alone or in combination of two or more thereof.

The use amount of the polyfunctional monomer is changed depending on the molecular weight or the number of functional groups thereof, but the polyfunctional monomer is added in an amount within a range of 0.01 to 3.0% by mass, preferably within a range of 0.02 to 2.0% by mass, and more preferably within a range of 0.03 to 1.0% by mass, based on the total mass of the monomer components for preparing the acrylic polymer (A).

If the use amount of the polyfunctional monomer is more than 3.0% by mass based on the total mass of the monomer components for preparing the acrylic polymer (A), for example, the cohesive force of the acrylic pressure-sensitive adhesive layer 40 may become too large and accordingly there are sometimes the cases where the adhesive force is decreased. On the other hand, if the use amount thereof is less than 0.01% by mass, for example, there are sometimes the cases where the cohesive force of the pressure-sensitive adhesive layer 40 is decreased.

### <Polymerization Initiator>

In preparing the acrylic polymer (A), the acrylic polymer (A) can be easily formed by a curing reaction using heat or ultraviolet rays with the use of a polymerization initiator, such as a thermal polymerization initiator, photo-polymerization initiator (photo-initiator), or the like. In particular, a photo-polymerization initiator can be preferably used in terms of the advantage that a polymerization time can be shortened. The polymerization initiator can be used alone or in combination of two or more thereof.

Examples of the thermal polymerization initiator include, for example: azo polymerization initiators [for example, 2,2′-azobisisobutyronitrile, 2,2′-azobis-2-methylbutyronitrile, 2,2′-azobis(2-methylpropionic acid)dimethyl, 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl) propane]dihydrochloride, 2,2′-azobis(2-methylpropionamidine)disulfate, and 2,2′-azobis (N,N′-dimethyleneisobutylamidine)dihydrochloride, etc.]; peroxide polymerization initiators (for example, dibenzoyl peroxide, t-butyl permaleate, and lauroyl peroxide, etc.); and redox polymerization initiators, etc.

The use amount of the thermal polymerization initiator is not particularly limited, and only has to be within a conventional range in which it can be used as a thermal polymerization initiator.

The photo-polymerization initiator is not particularly limited, but, for example, a benzoin ether photo-polymerization initiator, acetophenone photo-polymerization initiator, α-ketol photo-polymerization initiator, aromatic sulfonyl chloride photo-polymerization initiator, photoactive oxime photo-polymerization initiator, benzoin photo-polymerization initiator, benzyl photo-polymerization initiator, benzophenone photo-polymerization initiator, ketal photo-polymerization initiator, thioxanthone photo-polymerization initiator, acylphosphine oxide photo-polymerization initiator, or the like, can be used.

Specific examples of the benzoin ether photo-polymerization initiator include, for example: benzoin methyl ether, benzoin ethyl ether, benzoin propyl ether, benzoin isopropyl ether, benzoin isobutyl ether, 2,2-dimethoxy-1,2-diphenylethane-1-one [made by BASF, product name: IRGACURE 651,], and anisoin, etc. Specific examples of the acetophenone photo-polymerization initiator include, for example: 1-hydroxycyclohexyl phenyl ketone [made by BASF, product name: IRGACURE 184], 4-phenoxy dichloroacetophenone, 4-t-butyl-dichloroacetophenone, 1-[4-(2-hydroxyethoxy)-phenyl]-2-hydroxy-2-methyl-1-propane-1-one [made by BASF, product name: IRGACURE 2959], 2-hydroxy-2-methyl-1-phenyl-propane-1-one [made by BASF, product name: DAROCUR 1173], and methoxy acetophenone, etc. Specific examples of the α-ketol photo-polymerization initiator include, for example: 2-methyl-2-hydroxy propiophenone and 1-[4-(2-hydroxyethyl)-phenyl]-2-hydroxy-2-methylpropane-1-one, etc. Specific examples of the aromatic sulfonyl chloride photo-polymerization initiator include, for example, 2-naphthalene sulfonyl chloride, etc. Specific examples of the photoactive oxime photo-polymerization initiator include, for example, 1-phenyl-1,2-propanedione-2-(O-ethoxycarbonyl)-oxime, etc.

Specific examples of the benzoin photo-polymerization initiator include, for example, benzoin, etc. Specific examples of the benzyl photo-polymerization initiator include, for example, benzyl, etc. Specific examples of the benzophenone photo-polymerization initiators include, for example, benzophenone, benzoylbenzoic acid, 3,3′-dimethyl-4-methoxybenzophenone, polyvinyl benzophenone, and α-hydroxy cyclohexyl phenyl ketone, etc. Specific examples of the ketal photo-polymerization initiator include, for example, benzyl dimethyl ketal, etc. Examples of the thioxanthone photo-polymerization initiator include, for example; thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone, etc.

Examples of the acylphosphine photo-polymerization initiator include, for example: bis(2,6-dimethoxybenzoyl)phenylphosphine oxide, bis(2,6-dimethoxybenzoyl)(2,4,4-trimethylpentyl) phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl) phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl) phosphine oxide, bis(2,6-dibutoxybenzoyl)(2-methylpropane-1-yl) phosphine oxide, bis(2,4-dimethoxybenzoyl)(2-methypropane-1-yl)phosphine oxide, bis(2,4,6-trimethylbenzoyl)(2,4-dipentoxyphenyl) phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphin e oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

Among them, bis(2,4,6-trimethylbenzoyl)phenylphosphine oxide [made by BASF, product name: IRGACURE 819], bis(2,4,6-trimethyl benzoyl)-2,4-di-n-butoxy phenylphosphine oxide, 2,4,6-trimethylbenzoyl diphenylphosphine oxide [made by BASF, product name: Lucirin TPO], and bis(2,6-dimethoxybenzoyl)-2,4,4-trimethylpentylphosphine oxide are preferably used.

The use amount of the photo-polymerization initiator is not particularly limited, but the photo-polymerization initiator is combined, for example, in an amount within a range of 0.01 to 5 parts by mass, preferably within a range of 0.05 to 3 parts by mass, and more preferably within a range of 0.08 to 2 parts by mass, based on 100 parts by mass of the monomer components for preparing the acrylic polymer (A).

If the use amount of the photo-polymerization initiator is less than 0.01 parts by mass, there are sometimes the cases where a polymerization reaction becomes insufficient. If the use amount thereof is more than 5 parts by mass, there are sometimes the cases where an ultraviolet ray does not reach the inside of the pressure-sensitive adhesive layer 40, because the photo-polymerization initiator absorbs an ultraviolet ray, thereby causing the fear that a rate of polymerization may be decreased. With the molecular weight of the generated polymer being small, the cohesive force of the formed pressure-sensitive adhesive layer 40 becomes small, and hence there are sometimes the cases where, when the pressure-sensitive adhesive layer 40 is peeled off from a film, part of the pressure-sensitive adhesive layer 40 remains on the film and accordingly the film cannot be reused. The photo-polymerization initiator may be used alone or in combination of two or more thereof.

In order to adjust the cohesive force, a cross-linking agent can also be used, other than the aforementioned polyfunctional monomers. Commonly-used cross-linking agents can be used as the cross-linking agent. Examples of the cross-linking agents include, for example: an epoxy cross-linking agent, isocyanate cross-linking agent, silicone cross-linking agent, oxazoline cross-linking agent, aziridine cross-linking agent, silane cross-linking gent, alkyl-etherified melamine cross-linking agent, and metal chelate cross-linking agent, etc. In particular, an isocyanate cross-linking agent and an epoxy cross-linking agent can be preferably used.

Specific examples of the isocyanate cross-linking agent include: tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylylene diisocyanate, naphthalene diisocyanate, triphenylmethane triisocyanate, polymethylene polyphenyl isocyanate, and these adducts with polyols, such as trimethylolpropane.

Examples of the epoxy cross-linking agent include: bisphenol A, epichlorohydrin type epoxy resin, ethyleneglycidylether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, diamine glycidyl amine, N,N,N′,N′-tetraglycidyl-m-xylylenediamine, and 1,3-bis(N,N-diglycidyl aminomethyl)cyclohexane, etc.

Various additives may be blended in the pressure-sensitive adhesive. Examples of such additives include, for example: cross-linking agents, such as isocyanate cross-linking agent and epoxy cross-linking agent; tackifiers, such as rosin derivative resin, polyterpene resin, petroleum resin, and oil soluble phenol resin; plasticizers; fillers; anti-aging agents; surfactants; and pigments (colorants), etc.

A method of forming the pressure-sensitive adhesive layer 40 is not particularly limited, but is formed by, for example, coating the pressure-sensitive adhesive on an appropriate supporting body, such as a separator or substrate, to form a pressure-sensitive adhesive layer, and then by drying or curing the coated layer (curing with heat or active energy rays), if necessary. In curing the coated layer with active energy rays (light curing), a photo-polymerization reaction is inhibited by the oxygen in the air; accordingly, it is preferable to block the oxygen by laminating an appropriate supporting body, such as a separator or substrate, on the pressure-sensitive adhesive layer 40, or by performing light curing under nitrogen atmosphere. The appropriate supporting body to be used in forming the pressure-sensitive adhesive layer 40 may be peeled off at an appropriate timing during the formation of the pressure-sensitive adhesive tape or peeled off when the produced pressure-sensitive adhesive tape is used.

The thickness of the pressure-sensitive adhesive layer 40 can be appropriately selected in accordance with the use purpose of the pressure-sensitive adhesive tape, but is, for example, within a range of 1 to 300 μm, preferably within a range of 10 to 250 μm, and more preferably within a range of approximately 30 to 200 μm. If the thickness thereof is too small, there are sometimes the cases where the adhesive force enough for holding an adherend cannot be obtained.

The fingerprint-resistant treated layer 50 is laminated on a major surface of the substrate layer 20, the major surface being opposite to the colored layer 30. That is, the outer surface of the fingerprint-resistant treated layer 50 becomes the back surface (exposed surface) of the fingerprint-resistant pressure-sensitive adhesive tape 10, which a finger of a user touches when the fingerprint-resistant pressure-sensitive adhesive tape 10 is adhered to an adherend. The fingerprint-resistant treated layer 50 is not particularly limited, but can be formed by coating, for example, a paint described in Japanese Patent Application Publication No.

1998-306237. Among such paints, a paint containing both an adipic acid ester, such as ethyl adipate, and a nitrogen-containing component, such as isophorone diisocyanate, is more preferable.

The thickness of the fingerprint-resistant treated layer 50 is not particularly limited, but is preferable, for example, more than 0 μm to 2 μm or less, more preferably within a range of 0.4 to 2 μm, still more preferably within a range of 0.6 to 1.4 μm, and particularly preferably within a range of 0.8 to 1.2 μm. The outer surface of the fingerprint-resistant treated layer 50, opposite to the core layer, is subjected to a fingerprint-resistant treatment, and Wa of the surface is 150 angstroms or more and Ra thereof is 2000 angstroms or more. Herein, Wa means an arithmetic average waviness representing an average of absolute values of contour curves in reference lengths (contour curves picked in order to calculate a surface roughness or a waviness component). In addition, Ra means an arithmetic average roughness. Each of Wa and Ra of the outer surface of the fingerprint-resistant treated layer 50 can be evaluated by using a profilometer (product name: P-11 (made by Tencor)). The aforementioned Wa is preferably 200 angstroms or more, more preferably 250 angstroms or more, still more preferably 300 angstroms or more, and particularly preferably 350 angstroms or more. The upper limit thereof is not particularly limited, but may be 1000 angstroms or less, preferably 900 angstroms or less, and more preferably 800 angstroms or less. The aforementioned Ra is preferably 2100 angstroms or more. The upper limit thereof is not particularly limited, but may be 5000 angstroms or less, preferably 4000 angstroms or less, and more preferably 3000 angstroms or less.

According to the aforementioned fingerprint-resistant pressure-sensitive adhesive tape 10, the fingerprint-resistant treated layer 50 is exposed on the surface of the tape 10, without the colored layer 30 being exposed thereon, and hence the colored layer 30 is protected. Further, when a finger touches the back surface of the fingerprint-resistant pressure-sensitive adhesive tape 10, it becomes possible to make the fingerprint inconspicuous by the fingerprint-resistant treated layer 50. Furthermore, because the colored layer 30 and the fingerprint-resistant treated layer 50 are provided separately from each other, the coloring property and the fingerprint resistance of the tape can be both achieved.

In particular, when the colored layer 30 is black, it becomes possible to make an adherend hardly visible by the light blocking effect of the colored layer 30, and it also becomes possible to make a fingerprint inconspicuous by the fingerprint-resistant treated layer 50 when a finger touches the back surface of the tape 10. As a result, the design of a product including the adherend to which the fingerprint-resistant pressure-sensitive adhesive tape 10 has been adhered can be improved.

### Embodiment 2

FIG. 2 is a schematic view illustrating the layer structure of the fingerprint-resistant pressure-sensitive adhesive tape 10 according to Embodiment 2. The fingerprint-resistant pressure-sensitive adhesive tape 10 comprises a core layer including the substrate layer 20 and the colored layer 30, the pressure-sensitive adhesive layer 40, and the fingerprint-resistant treated layer 50. The structure of the fingerprint-resistant pressure-sensitive adhesive tape 10 according to the present embodiment is the same as that of the fingerprint-resistant pressure-sensitive adhesive tape 10 according to Embodiment 1, except that the lamination order of the substrate layer 20 and the colored layer 30 in the core layer is opposite to that in Embodiment 1. That is, in the present embodiment, the fingerprint-resistant treated layer 50 touches the colored layer 30, and the pressure-sensitive adhesive layer 40 touches the substrate layer 20.

Also, by the fingerprint-resistant pressure-sensitive adhesive tape 10 according to the present embodiment, it becomes possible to make an adherend hardly visible, and it becomes possible to make a fingerprint inconspicuous when a finger touches the back surface of the tape 10, similarly to Embodiment 1.

### EXAMPLES

Hereinafter, the present invention will be described in detail based on Examples, but the invention should not be limited at all by these Examples. Unless otherwise indicated, “part(s)” means “part(s) by mass” in the present embodiment.

(Production of Pressure-Sensitive Adhesive Composition)

Seventy parts by mass of butyl acrylate, 30 parts by mass of acrylic acid-2-ethylhexyl, 3 parts by mass of acrylic acid, and 0.05 parts by mass of 4-hydroxybutyl acrylate were subjected to solution polymerization in a mixed solution of toluene and ethyl acetate [toluene/ethyl acetate (mass ratio)=1/1] by using 0.08 parts by mass of 2,2-azobisisobutyronitrile as a polymerization initiator, in order to obtain an acrylic polymer having a weight average molecular weight of 500,000. Thirty parts by mass of a polymerized rosin pentaerythritol ester resin (product name: “PENSEL D125” made by ARAKAWA CHEMICAL INDUSTRIES, LTD.; softening point: 125° C.) and 3 parts by mass of an isocyanate cross-linking agent (product name: “CORONATE L” made by NIPPON POLYURETHANE INDUSTRY CO., LTD.) were added to 100 parts by mass of the acrylic polymer, and this mixture was stirred and mixed so as to be uniform, thereby allowing a pressure-sensitive adhesive (pressure sensitive adhesive composition) to be prepared.

### Example 1

A colored layer having a thickness of 1 μm was formed by printing the whole of one surface of a PET film having a thickness of 4 μm (transparent) by using black ink (the number of the printing is one). An acrylic pressure-sensitive adhesive layer (thickness: 23 μm) was formed on this colored layer by using the aforementioned pressure-sensitive adhesive. In addition, a fingerprint-resistant treated layer was laminated on the whole of the other surface of the PET film by using gravure printing, thereby allowing a pressure-sensitive adhesive tape (fingerprint-resistant pressure-sensitive adhesive tape) according to Example 1, having a layer structure of fingerprint-resistant treated layer/PET film/colored layer/acrylic pressure-sensitive adhesive layer, to be produced.

### Example 2

A pressure-sensitive adhesive tape according to Example 2 is the same as that in Example 1, except that the fingerprint-resistant treated layer was laminated on the colored layer and the acrylic pressure-sensitive adhesive layer was formed on the PET film. The pressure-sensitive adhesive tape according to Example 2 has a layer structure of acrylic pressure-sensitive adhesive layer/PET film/colored layer/fingerprint-resistant treated layer.

### Example 3

A pressure-sensitive adhesive tape according to Example 3 is the same as that in Example 1, except that a colored layer having a thickness of 1 μm was formed by printing the whole of one surface of a PET film having a thickness of 4 μm (transparent) by using gray ink and an acrylic pressure-sensitive adhesive layer was formed on the PET film. The pressure-sensitive adhesive tape according to Example 3 has a layer structure of fingerprint-resistant treated layer/PET film/colored layer/acrylic pressure-sensitive adhesive layer, similarly to Example 1.

### Comparative Example 1

A pressure-sensitive adhesive tape according to Comparative Example 1 is the same as that in Example 1, except that the fingerprint-resistant treated layer is not formed. That is, the back surface of the pressure-sensitive adhesive tape according to Comparative Example 1 is the outer surface of a PET film.

### Comparative Example 2

A pressure-sensitive adhesive tape according to Comparative Example 2 is the same as that in Example 2, except that the fingerprint-resistant treated layer is not formed. That is, the back surface of the pressure-sensitive adhesive tape according to Comparative Example 2 is the outer surface of the colored layer.

Ra and Wa of the pressure-sensitive adhesive tape of each of Examples and Comparative Examples were evaluated by using the profilometer (product name: P-11 (made by Tencor)). The results of the evaluation are shown in Table 1.

### (Fingerprint Resistance)

The fingerprint resistance of the pressure-sensitive adhesive tape of each of Examples and Comparative Examples was evaluated by touching the back surface of the tape with a finger, in which the case where a fingerprint was visible was evaluated as bad (x) and the case where a fingerprint was not visible was evaluated as good (°). The results of the evaluation are shown in Table 1.

TABLE 1

| | | | | COMPAR- | COMPAR- |
|---|---|---|---|---|---|
| | | | | ATIVE | ATIVE |
| | EXAM- | EXAM- | EXAM- | EXAM- | EXAM- |
| | PLE 1 | PLE 2 | PLE 3 | PLE 1 | PLE 2 |
| Ra(Å) | 2182.3 | 2416.6 | 2211.5 | 570 | 2322 |
| Wa(Å) | 399.5 | 494.4 | 385.6 | 74.2 | 93.9 |
| FINGER- | ∘ | ∘ | ∘ | x | x |
| PRINT | | | | | |
| RESIS- | | | | | |
| TANCE | | | | | |

As shown in Table 1, it has been confirmed that, in the pressure-sensitive adhesive tape according to each of Examples 1 and 2 including a fingerprint-resistant treated layer, a finger print is hardly visible, while in the pressure-sensitive adhesive tape according to each of Comparative Examples 1 and 2 not including a fingerprint-resistant treated layer, a fingerprint is likely to be visible.

What is claimed is:

1. A fingerprint-resistant pressure-sensitive adhesive tape comprising:
a core layer including a substrate layer formed of a plastic material and a colored layer laminated on one major surface of the substrate layer;
a pressure-sensitive adhesive layer laminated on one major surface of the core layer; and
a fingerprint-resistant treated layer laminated on the other major surface of the core layer, wherein
Wa of the surface of the fingerprint-resistant treated layer, opposite to the core layer, is 150 angstroms or more and Ra thereof is 2000 angstroms or more.

2. The fingerprint-resistant pressure-sensitive adhesive tape according to claim 1, wherein
the plastic material is polyethylene terephthalate.

3. The fingerprint-resistant pressure-sensitive adhesive tape according to claim 1, wherein
the pressure-sensitive adhesive layer contains an acrylic polymer whose monomer major component is (meth)acrylic acid alkyl ester.

4. The fingerprint-resistant pressure-sensitive adhesive tape according to claim 2, wherein
the pressure-sensitive adhesive layer contains an acrylic polymer whose monomer major component is (meth)acrylic acid alkyl ester.
